(19) United States
(12) Patent Application Publication
(10) Pub. No.: US 2021/0150281 A1
(43) Pub. Date: May 20, 2021

(54) DOMAIN ADAPTATION FOR SEMANTIC SEGMENTATION VIA EXPLOITING WEAK LABELS

(71) Applicant: NEC Laboratories America, Inc., Princeton, NJ (US)

(72) Inventors: Yi-Hsuan Tsai, Santa Clara, CA (US); Samuel Schulter, New York, NY (US); Manmohan Chandraker, Santa Clara, CA (US); Sujoy Paul, Riverside, CA (US)

(21) Appl. No.: 17/094,139

(22) Filed: Nov. 10, 2020

Related U.S. Application Data
(60) Provisional application No. 62/935,341, filed on Nov. 14, 2019.

(51) Int. Cl. G06K 9/62; G06N 3/08; G06F 16/55; G06K 9/34

(52) U.S. Cl. CPC G06K 9/6259; G06K 9/34; G06F 16/55; G06N 3/08

(57) ABSTRACT

Systems and methods for adapting semantic segmentation across domains is provided. The method includes inputting a source image into a segmentation network, and inputting a target image into the segmentation network. The method further includes identifying category wise features for the source image and the target image using category wise pooling, and discriminating between the category wise features for the source image and the target image. The method further includes training the segmentation network with a pixel-wise cross-entropy loss on the source image, and a weak image classification loss and an adversarial loss on the target image, and outputting a semantically segmented target image.

### RELATED APPLICATION INFORMATION

This application claims priority to Provisional Application No. 62/935,341, filed on Nov. 14, 2019, and incorporated herein by reference in its entirety.

### BACKGROUND

### Technical Field

The present invention relates to a convolutional neural network-based approaches for semantic segmentation, and more particularly to a semantic segmentation model that can generalize to previously unseen domains.

### Description of the Related Art

Semantic segmentation refers to the process of assigning or linking each pixel in an image to a semantic or class label. These labels can identify a person, animal, car, tree, road, lamp, mailbox, etc. Semantic segmentation can be considered image classification at a pixel level. Instance segmentation can label the separate instances of a plurality of the same object that appears in an image, for example, to count the number of objects. Semantic segmentation and instance segmentation can allow models to understand the context of an environment. The deficiency of segmentation labels is one of the main obstacles to semantic segmentation in the wild (e.g., real world images).

Models usually learn by collecting data from the same domain, for example, images from a city, farm, mountains, etc., and then apply these learned models to another domain (e.g., different city, different farm, different mountains, etc.). Performance, however, can be significantly reduced due to a domain gap, such as different types of roads various architectural styles of buildings, different types of animals, or different types of mountain terrain, between the training set and domain to which the model is applied.

### SUMMARY

According to an aspect of the present invention, a method is provided for adapting semantic segmentation across domains. The method includes inputting a source image into a segmentation network, and inputting a target image into the segmentation network. The method further includes identifying category wise features for the source image and the target image using category wise pooling, and discriminating between the category wise features for the source image and the target image. The method further includes training the segmentation network with a pixel-wise cross-entropy loss on the source image, and a weak image classification loss and an adversarial loss on the target image, and outputting a semantically segmented target image.

According to another aspect of the present invention, a processing system is provided for adapting semantic segmentation across domains. The processing system includes one or more processor devices, a memory in communication with at least one of the one or more processor devices and a display screen, wherein the processing system includes a segmentation network configured to receive a source image and receive a target image, a category wise pooler configured to identify category wise features for the source image and the target image using category wise pooling, a discriminator configured to discriminate between the category wise features for the source image and the target image, training the segmentation network with a pixel-wise cross-entropy loss on the source image, and a weak image classification loss and an adversarial loss on the target image; wherein the segmentation network is trained based on a pixel-wise cross-entropy loss on the source image, and a weak image classification loss and an adversarial loss on the target image, and outputs a semantically segmented target image on the display screen.

According to yet another aspect of the present invention, a non-transitory computer readable storage medium comprising a computer readable program for producing a road layout model is provided, wherein the computer readable program when executed on a computer causes the computer to perform the steps of inputting a source image into a segmentation network, inputting a target image into the segmentation network, identifying category wise features for the source image and the target image using category wise pooling, discriminating between the category wise features for the source image and the target image, training the segmentation network with a pixel-wise cross-entropy loss on the source image, and a weak image classification loss and an adversarial loss on the target image, and outputting a semantically segmented target image.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram illustrating a source image depicting a city scene, in accordance with an embodiment of the present invention;

FIG. 2 is a diagram illustrating a source image depicting a farm scene, in accordance with an embodiment of the present invention;

FIG. 3 is a diagram illustrating a target image depicting a city scene, in accordance with an embodiment of the present invention;

FIG. 4 is a diagram illustrating a target image depicting a farm scene, in accordance with an embodiment of the present invention;

FIG. 5 is a flow diagram illustrating a system/method for applying weak labels that can be used to improve domain adaptation, in accordance with an embodiment of the present invention;

FIG. 6 is a block/flow diagram illustrating a high-level system/method for transferring the knowledge learned from one domain to other new domains, in accordance with an embodiment of the present invention;

FIG. 7 is a block/flow diagram illustrating a system/method of passing both target and source images through a segmentation network G to obtain their features, and formulate a mechanism to align the features of each individual category between source and target domains, in accordance with an embodiment of the present invention;

FIG. 8 is an exemplary processing system to which the present methods and systems may be applied, in accordance with an embodiment of the present invention;

FIG. 9 is an exemplary processing system 900 configured to implement one or more neural networks for adapting semantic segmentation across domains, in accordance with an embodiment of the present invention; and

FIG. 10 is a block diagram illustratively depicting an exemplary neural network in accordance with another embodiment of the present invention.

### DETAILED DESCRIPTION OF PREFERRED EMBODIMENTS

In accordance with embodiments of the present invention, systems and methods are provided to/for transferring the knowledge learned from one domain (e.g., a source domain) to other new domains (e.g., target domains), without the need for re-collecting annotated data, which is a labor-intensive and expensive process. In various embodiments, category-wise feature alignment across domains, in which only categories that are present in the image are used for alignment, can be performed. Discrepancies can exist in the images of the training sets and the images of the test stage. Domain adaptation aims to rectify these discrepancies and tune the models toward better generalization for testing.

Domain adaptation for semantic segmentation is useful because manually labeling large datasets with pixel-level labels is expensive and time consuming, particularly when done by experts. Manually annotating large datasets with dense pixel-level labels can be costly due to the large amount of human effort involved. Convolutional neural network-based approaches for semantic segmentation can rely on supervision with pixel-level ground truth(s), but may not generalize well to previously unseen image domains. A ground truth may only be available for a source domain image(s), not for a target domain image(s), since the labeling process is tedious and labor intensive. Domain adaptation can be used to align synthetic and the real datasets; however, the visual (e.g., appearance, scale, etc.) domain gap between synthetic and real data can make it difficult for the network to learn transferable knowledge to be applied to a target domain.

Unsupervised domain adaptation (UDA) involves situations where no labels from the target domain are available. Methods for unsupervised domain adaptation (UDA) can be developed through domain alignment and pseudo label re-training. Pixel-wise pseudo labels can be generated via strategies such as confidence scores or self-paced learning. Pixel-wise pseudo labels in each category can be used as the guidance to align category-wise features. An auxiliary classification task using a form of categorical weak labels on the image-level of the target image can be introduced to reduce the effects of noisy pixel-wise pseudo labels, where weak labels do not identify every pixel of an image as belonging to a particular class or category, but specifies the existence of a class or category of an object in the image. This design can reduce the noisy alignment process that may consider categories that do not exist in the target image by first specifying which categories are present in the image.

Various embodiments do not utilize regularizations through techniques of domain alignment, which can include feature-level, output space, and patch-level alignment.

In various embodiments, self-learning schemes such as pixel-wise pseudo labeling methods are not used to enhance the performance in the target domain.

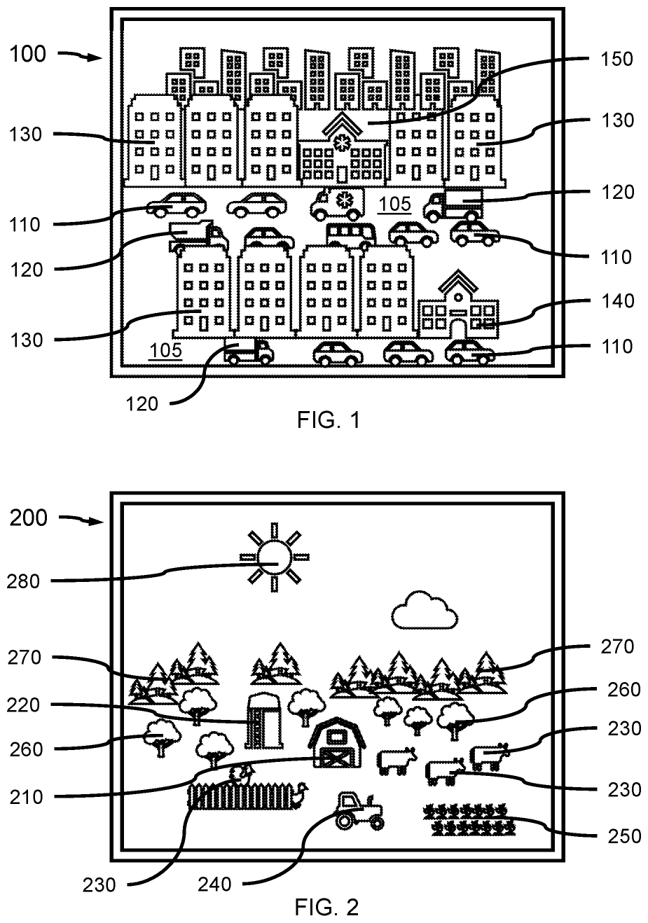

Referring now in detail to the figures in which like numerals represent the same or similar elements and initially to FIG. 1, a diagram illustrating a source image depicting a city scene is shown, in accordance with an embodiment of the present invention.

In various embodiments, a, source image 100 of a scene, for example, of a city can include numerous objects and features. Various vehicles, including, but not limited to, cars 110, trucks 120, busses, and ambulances, can be on roadways. Building of different types and sizes, including but not limited to apartment buildings 130, schools 140, and hospitals 150 can be on opposite sides of the roadways. The source image, Xₛⁱ, could be captured on an overcast day when no sun is visible. This can cause the appearance of the objects/features of the image to be different from the same scene captured on a sunny day.

In various embodiments, when a source image undergoes semantic segmentation, each pixel of the image has a semantic label applied to indicate the class or category of the feature to which the pixel belongs.

FIG. 2 is a diagram illustrating a source image depicting a farm scene, in accordance with an embodiment of the present invention;

In various embodiments, a, source image 200 of a farm scene can include numerous objects and features different from the city scene in FIG. 1. Various vehicles, including, but not limited to, tractors 240, cars, and trucks, can be on a farm. Building of different types and sizes, including but not limited to, barns 210, silos 220, and a farmhouse can be on the farm. The source image, X_{S}ⁱ, could be captured on a sunny day when the sun 280 is shining. This can cause the appearance of the objects/features of the image to be different from the same scene captured at night or on a rainy or snowy day.

A farm may also include different types of farm animals 230, for example, roosters, cows, pigs, sheep, chickens, and ducks. A farm may also have plants 250, that may be vegetable plants of different varieties (e.g., wheat, corn, tomatoes, green beans, soy beans, etc.). There may be deciduous trees 260, evergreen trees 270, and/or fruit trees present.

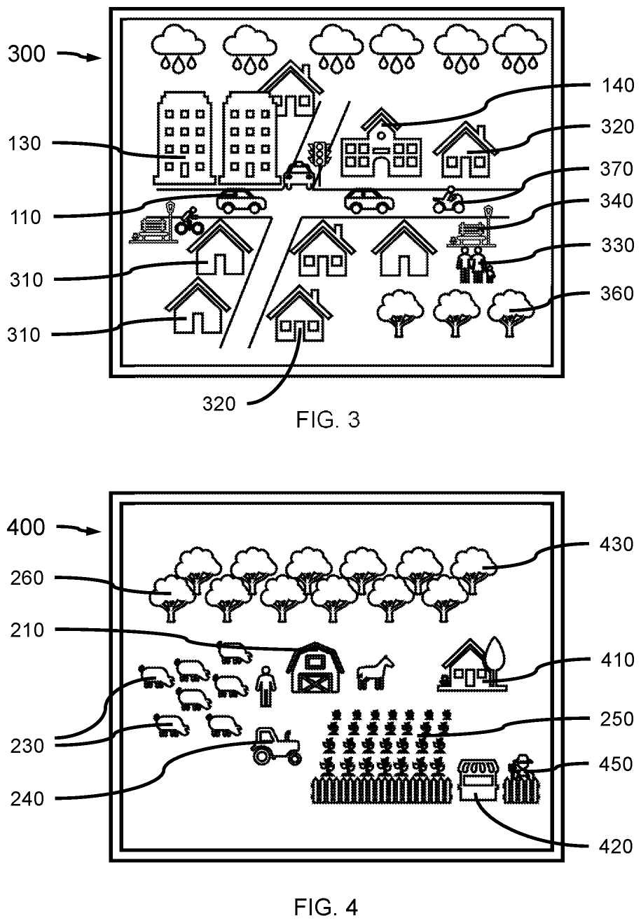

FIG. 3 is a diagram illustrating a target image depicting a city scene, in accordance with an embodiment of the present invention;

In various embodiments, a target image 300 of a city scene, for example, can include numerous objects and features different from the source image 100 of a different city scene, for example, in FIG. 1. Various vehicles, including, but not limited to, cars 110, trucks, busses, motorcycles 370, and ambulances, can be on roadways, but the actual vehicles present in the target image may be different from those in the source image 100. Building of different types and sizes, including but not limited to, single family houses 310, two family houses 320, apartment buildings 130, schools 140, and hospitals can be on opposite sides of the roadways. The target image, Xₜⁱ, could be captured on a rainy day when no sun is visible. This can cause the appearance of the objects/features of the image 300 to be different from the same scene captured on a sunny day.

City scenes from different cities can also have different architectural styles (e.g., onion domes in Russia, upturned roof corners in east Asia, vehicles can be on different sides of the road, traffic signs can have different orientations and/or symbols, and people can be dressed differently.

FIG. 4 is a diagram illustrating a target image depicting a farm scene, in accordance with an embodiment of the present invention;

In various embodiments, a target image 400 of a farm scene can include numerous objects and features different from the farm scene 200 depicted in FIG. 2. Various vehicles, including, but not limited to, tractors 240, cars, and trucks, can be on the farm, but there may be different types of tractors, cars, and trucks present in the scene. Building of different types and sizes, including but not limited to, a farmhouse 410, silos 220, a farm stand 420, and a barn, can be on the farm. The target image, Xₜⁱ, could be captured at dusk. This can cause the appearance of the objects/features of the image to be different from the same scene captured at noon on a sunny day or early morning on a rainy day.

A farm may also include different types of farm animals 230, for example, roosters, cows, pigs, sheep, chickens, and ducks. A farm may also have crops/plants 250, that may be vegetable plants of different varieties (e.g., corn, tomatoes, green beans, soy beans, etc.). There may be deciduous trees 260, evergreen trees, and/or fruit trees 430 present to form an orchard.

The variation(s) in the appearance of a scene can create a domain gap that can reduce scene understanding. Even within the same city, the weather and time of-day could create numerous differences. An approach is to leverage synthetic data, in which annotations can be obtained at a much lower cost. Knowledge-transfer modules allow us to perform better scene understanding in the real world.

In one or more embodiments, weak labels can be used to improve domain adaptation, where weak labels can reduce or avoid the cost and effort of strong classification of every pixel in an image. The proposed domain adaptation method can utilize a self-learning scheme via predicting weak labels of each target image/data, where this process is referred to as pseudo-weak label generation. For example, given a road-scene image in the target domain, which categories are present in that image can be predicted, e.g., road, car, truck, and pedestrian, without knowing their exact locations in the image. Second, these predicted categories can be used to regularize and self-teach the model, in which the model is able to suppress task predictions for those categories that do not present in the images, and vice versa. The domain alignment process can be improved through use of the predicted weak labels. Category-wise feature alignment can be performed across domains, in which only categories that present in the image are used for alignment. This design can reduce the noisy alignment process that may consider categories that do not exist in the target image.

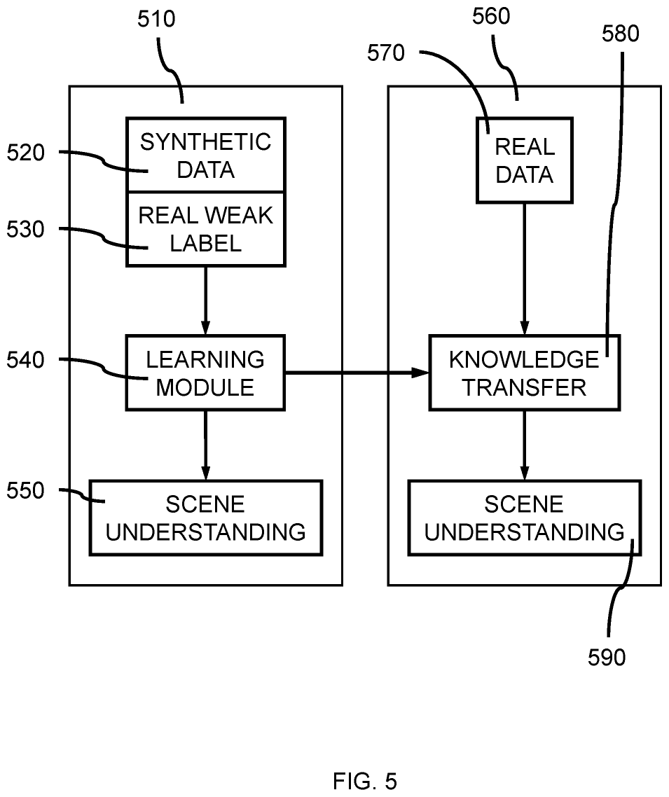

FIG. 5 is a block/flow diagram illustrating a high-level system/method for transferring the knowledge learned from one domain to other new domains, in accordance with an embodiment of the present invention.

In a training phase 510, at block 520 synthetic data/images can be generated. At block 530 weak labels can be assigned to the synthetic data/images, where the weak labels identify which categories appear in the synthetic image(s)/data. At block 540 a learning module, which can include a neural network, can learn which categories appear in the synthetic image(s)/data to develop scene understanding 550.

In a testing phase 560, at block 570, real image(s)/data having attached weak labels can be introduced to a knowledge transfer module 580, which can include a neural network, that has been trained in training phase 510 to develop scene understanding 590 of the real images/data 570.

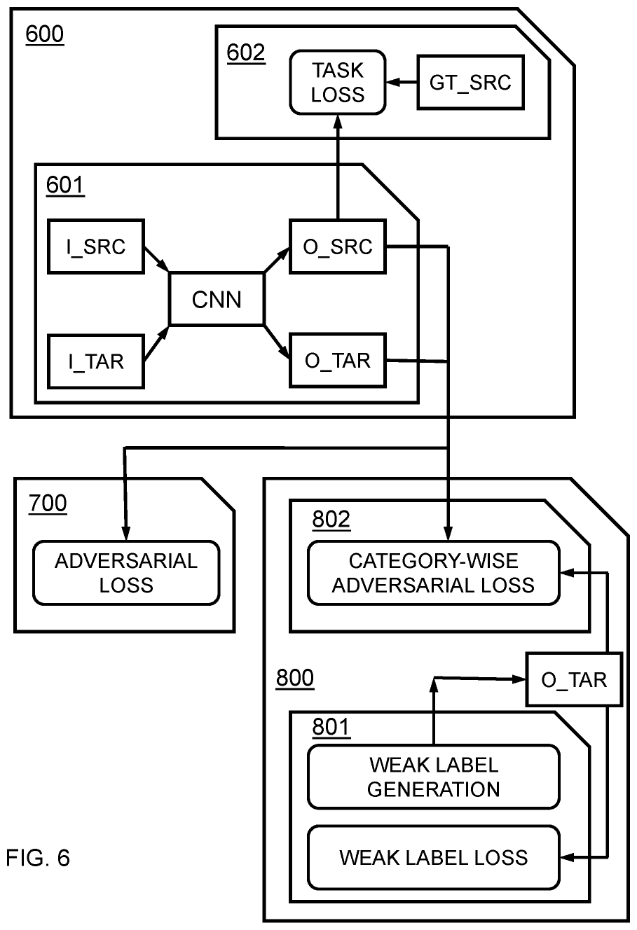

FIG. 6 is a diagram illustrating a , in accordance with an embodiment of the present invention.

In block 600, a main task is shown, where a neural network (NN) is applied to learn models by using synthetic data for a first domain for training and applying the learned models to another different domain from the real world by predicting weak labels of each target data.

In block 601, input images can come from two domains (e.g., source, target) that can be different, where source images can be denoted as (I_src), and target images can be denoted as (I_tar), (i.e., I_scr=input image from source domain; I_tar=Input image from target domain), which can also be referred to as Xₛ and Xₜ, respectively. These inputs are fed into a neural network, for example, a convolutional neural network (CNN), that predicts the task's segmentation output, that is, per-pixel labels for the category to which that pixel belongs, where for both domains, O_src and O_tar (O_scr=output image from source domain, and O_tar=output image from target domain) (i.e., O_src and O_tar stand for the outputs). Since the task can be a pixel-by-pixel labeling task, the outputs can be considered as H×W images (height×width), where every pixel in the image has a color value corresponding to the identifying category number. In this case, the output is semantic segmentation, i.e., assigning a semantic category like road, car, person, etc., to each pixel in the image(s). The output of the segmentation neural network can be interpreted as an image with color values equal to the category number assigned to that pixel. Semantic segmentations can be considered structured outputs that contain spatial similarities between the source and target domains. Adversarial learning can be adopted in the output space. A multi-level adversarial network can be constructed to effectively perform output space domain adaptation at different feature levels.

In block 602, for images from the source domain there are also given ground truth labels (GT_src), which are used in a standard supervised loss function (Task Loss) to train the neural network from block 601. Ground truth means human annotated segmentation, which is used for training. A ground truth may only be available for a source domain, not for target domain, where human annotated segmentation is available for use in training a neural network.

In block 700, in order to train the NN in block 601 and also handle images from the target domain (I_tar), an adversarial loss function (or regularization) can be applied to encourage the distribution of both O)src and O_tar to be similar, where the distributions of O_src and O_tar can be required to have similar statistics, through adversarial loss. Note that no ground truth data is available for the target domain. This loss function has an internal NN that tries to distinguish between the two domains (e.g., images), which can then be used for distribution alignment.

In block 800, domain adaptation can be implemented by considering weak labels, where the weak labels are human annotated. In various embodiments, a user (e.g., expert) may identify the categories present in an image and attach a corresponding weak label to the image (e.g., target image).

In block 801, in order to improve the module in block 601 with category-wise information, block 801 can be used to generate weak labels for target image(s) (i.e., W_tar), i.e., image-level labels, for example, whether pedestrian(s) are presents in the image, or whether the image scene is in a city or of a farm. Note that, in the unsupervised setting, pseudo weak labels can be produced directly from O_tar in block 601, while the system/method also allows users to provide ground truth weak labels by manual annotation. Once the weak labels are generated, a weak-label loss can be employed to suppress categories that are not present in the target image, while enhancing predictions for categories present in the target image.

In block 802, with the weak labels (W_tar) provided in block 801 and overall distributions (O_src and O_tar) from block 601, block 700 can be improved by adding a category-wise adversarial loss to specifically align category-wise feature distributions across source and target domains. For instance, if the input image contains the label of “car” but not a “bike” category, we align the distribution of car but not for the bike. This is different from previous methods that may use block 700 and align distributions without considering category-wise information. To realize our category-wise adversarial loss function, an internal NN can be employed for each category that tries to distinguish whether the distribution of this category comes from the source domain or the target domain. Therefore, category-wise alignment via computing adversarial loss for every category can be performed accordingly.

To tackle the domain gap issue, methods for unsupervised domain adaptation (UDA) are developed through domain alignment and pseudo label re-training. To reduce the effect of noisy pixel-wise pseudo labels, an auxiliary classification task using a form of categorical weak labels on the image-level of the target image can be used. In various embodiments, model is able to simultaneously perform pseudo label re-training and feature alignment. A classification objective can predict whether a category is present in the target image, and the model is able to produce a pixel-wise attention map that indicates the probability map for a certain category. The attention map can be used for guidance to pool category-wise features for an alignment procedure. Image-level annotations identify categories present in an image without identifying location(s).

In one or more embodiments, a source domain with pixel-wise ground truth labels can be used, whereas in the target domain, pseudo weak labels or ground truth weak labels can be used.

In the source domain, there can be images and pixel-wise labels denoted as Iₛ={X_{S}ⁱ, Y_{S}ⁱ}ᵢ₌₁^{N}^{_{S}}, where X_{S}ⁱ represents a source domain image, and Y_{S}ⁱ is the ground truth annotations for source images, and “i” is an index differentiating the source images and annotations. Whereas, a target dataset can contain images and only image-level labels as Iₜ={Xₜⁱ, Yₜⁱ}ᵢ₌₁^{N}^{ₜ}, where Xₜⁱ represents a target domain image, and Yₜⁱ are image-level labels referred to as weak labels, and “i” is an index differentiating the target images and weak labels. Note that Xₓ, Xₜ∈ [symbol] ^{H×W×3}, Yₛ∈ [symbol] ^{H×W×C} are pixel-wise one-hot vectors, yₜ∈ [symbol] ^{C} is a multi-hot vector representing the categories available in the image and C is the number of categories, same for both the source and target datasets. [symbol] is a space of real numbers. H is the height and W is the width of an image, which can be in pixels. The value of 3 is a current value for the number of channels. [symbol] is a space of Boolean numbers (e.g., 0 or 1). A “one hot vector” is a vector with a single coordinate having a value of 1 and the rest of the coordinates of the vector have a value of 0. Such image-level labels yₜ are weak labels, which may be acquired with or without a human expert, i.e., the WDA or UDA setting. A segmentation model, G, learned/trained on the source dataset, Iₛ, can be adapted to the target dataset, Iₜ.

In various embodiments, both the target and source images are passed through the segmentation network, G, and obtain their features, Fₛ; Fₜ, ∈ [symbol] ^{H′×W′×2048}, where 2048 is a parameter choice for the number of channels, Fₛ; Fₜ, represent the source features and target features, respectively, and segmentation predictions, Aₛ; Aₜ∈ [symbol] ^{H′×W′×C}, and the up-sampled pixel-wise predictions Oₛ, Oₜ∈ [symbol] ^{H′×W′×C}. As a baseline, the source pixel-wise annotations can be used to learn/train G, while aligning the output space Oₛ and Oₜ using an adversarial loss and a discriminator.

In various embodiments, the domain adaptation algorithm can include two modules: a segmentation network, G, and the discriminator, Dᵢ, where i indicates the level of a discriminator in the multilevel adversarial learning. Two sets of images, Xₛ, Xₜ∈ [symbol] ^{H×W×3}, from source and target domains are denoted as {I_{S}} and {I_{T}}, respectively. In various embodiments, the source images Xₛ (with annotations) can be forwarded to the segmentation network for optimizing G. Then the segmentation softmax output Pₜ can be predicted for the target images Xₜ (without annotations). Making segmentation predictions P of source and target images (i.e., Pₛ and Pₜ) close to each other, these two predictions can be used as the input to the discriminator Dᵢ to distinguish whether the input is from the source or target domain. With an adversarial loss, [symbol] _{adv}, on the target prediction, the network can propagate gradients from Dᵢ to G, which would encourage G to generate similar segmentation distributions in the target domain to the source prediction.

In various embodiments, the adaptation task can include two loss functions from both modules:

[symbol]

(Iₛ, Iₜ)= [symbol] _{seg}(Iₛ)+λ_{adv} [symbol] _{adv}(Iₜ),

where L_{seg} is the cross-entropy loss using ground truth annotations in the source domain, and L_{adv} is the adversarial loss that adapts predicted segmentations of target images to the distribution of source predictions. λ_{adv} is the weight used to balance the two losses. Although segmentation outputs are in the low-dimensional space, they contain rich information, e.g., scene layout and context.

Given the segmentation softmax output P=G(I)∈ [symbol] ^{H′×W′×C}, where C is the number of categories, we forward segmentation predictions, P, to a fully-convolutional discriminator D using a cross-entropy loss L_{d} for the two classes (i.e., source and target). The loss can be written as:

[symbol]

_{d}(P)=−Σ_{h,w}(1−z)log(D(P)^{(h,w,0)})+z log(D(P)^{(h, w, 1)})

where z=0 if the sample is drawn from the target domain, and z=1 for the sample from the source domain. And where [symbol] _{d} is the cross-entropy loss for the discriminator, D, for the two classes. P are the forward segmentation predictions, and h and w are the height and width if the image.

In various embodiments, the segmentation loss in can be defined as the cross-entropy loss for images from the source domain:

[symbol]

_{seg}(Iₛ)=−Σ_{h,w}Σ_{c∈C}Y_{S}^{(h,w,c)} log(Pₛ^{(h,w,c)}),

where Yₛ is the ground truth annotations for source images and Pₛ=G(Iₛ) is the segmentation output. [symbol] _{seg}(Iₛ) is the Loss function for the segmentation network, G, applied to a set of source images, Iₛ. “h” is the height of the image. “w” is the width of the image. “c” is the categories in the image. Second, for images in the target domain, we forward them to G and obtain the prediction Pₜ=G(Iₜ). Iₜ is a set of target images. To make the distribution of Pₜ closer to Pₛ, we use an adversarial loss, L_{adv}, as:

[symbol]

_{adv}(Iₜ)=−Σ_{h,w} log(D(Pₜ)^{h,w,1)})

This loss is designed to train the segmentation network, G, and fool the discriminator, D, by maximizing the probability of the target prediction being considered as the source prediction. Although performing adversarial learning in the output space directly adapts predictions, low-level features may not be adapted well as they are far away from the output.

In various embodiments, an additional adversarial module in the low-level feature space can be used to enhance the adaptation. The training objective for the segmentation network can be extended as:

[symbol]

(Iₛ, Iₜ)=Σᵢλₛₑⁱ [symbol] _{seg}ⁱ(Iₛ)+Σᵢλ_{adv}ⁱ [symbol] _{adv}ⁱ(Iₜ),

where i indicates the level used for predicting the segmentation output. [symbol] (Iₛ, Iₜ) is the combined loss function made up of [symbol] _{seg}ⁱ(Iₛ) and [symbol] _{adv}ⁱ(Iₜ), and their respective weighting factors. It is noted that, the segmentation output is still predicted in each feature space, before passing through individual discriminators for adversarial learning. Hence, [symbol] _{seg}ⁱ(Iₛ) and [symbol] _{adv}ⁱ(Iₜ) remain in the same form as the previous equations. The weight, λ_{seg}ⁱ, is the weighting factor applied to the Loss function, [symbol] _{seg}ⁱ, for the segmentation network, G. The weight, λ_{adv}ⁱ, is the weighting factor applied to the Adversarial Loss function, [symbol] _{adv}ⁱ.

The following min-max criterion can be optimized:

$${max}_{D} {min}_{G} ℒ ( {I}_{s} , {I}_{t} ) ,$$

with a goal to minimize the segmentation loss in G for source images, while maximizing the probability of target predictions being considered as source predictions.

For the discriminator, the architecture can utilize all fully-convolutional layers to retain the spatial information. The network can include 5 convolution layers with kernel 4×4 and stride of 2, where the channel number is {64, 128, 256, 512, 1}, respectively. Except for the last layer, each convolution layer can be followed by a leaky ReLU parameterized by 0.2 (ReLU is the rectified linear activation function). An up-sampling layer can be added to the last convolution layer for re-scaling the output to the size of the input. Batch-normalization layers may not be used, as the discriminator can be jointly trained with the segmentation network using a small batch size.

In addition to having pixel-wise labels on the source data, there can also be weak image-level labels on the target data. These weak labels can be utilized to learn G in two different ways. First, we include a module which learns to predict the categories that present in a target image. Second, motivated by domain alignment, we formulate a mechanism to align the features of each individual category between source and target domains. To this end, category-specific domain discriminators D^{c} can be guided by the weak labels to determine which categories should be aligned. In the following sections, we present these two modules in detail by utilizing the weak image-level labels.

In various embodiments, alignment of the output space Oₛ, Oₜ, where Output Space refers to the prediction at every pixel, specifying whether or not that pixel belongs to category k, where k−1, . . . , C. Here, C is total number of categories. This does not consider which categories are present in an image, but only their overall structure. As a result, for those objects that are usually identified partially or do not retain the complete shape, they may become less significant in the segmentation prediction, which increases the difficulty during alignment as such partial objects do not appear in the source data. An auxiliary task is introduced via weak labels by enforcing constraints on the categories that appear in the images. The weak labels, yₜ, are used and learn to predict the categories present/absent in the target images.

In various embodiments, the weak labels, yₜ, are used and learn to predict the categories present/absent in the target images. The target images, Xₜ, can be fed through G to obtain the predictions Aₜ of categories present/absent, and then apply a global pooling layer to obtain a single vector of predictions for each category:

$${P}_{t}^{c} = {σ}_{s} [ log \frac{1}{{H}^{′} {W}^{′}} {\sum }_{{h}^{′} , {w}^{′}} {exp A}_{t}^{( {h}^{′} , {w}^{′} , c )} ] ,$$

where σₛ is the sigmoid function such that predictions, pₜ, of category, C, for the target represents the probability that a particular category appears in a target image. Using pₜ and the weak labels yₜ, the category-wise binary cross-entropy loss can be computed:

[symbol]

_{c}(Xₜ; G)=Σ_{c=1}^{C}−yₜ^{c} log(pₜ^{c})−(1−yₜ^{c})log(1−pₜ^{c}).

This loss function, [symbol] _{c}, helps to identify the categories which are absent/present in a particular image and forces the segmentation network, G, to pay attention to those objects/entities that are partially identified. The category-wise features can be obtained for each image via an attention map. i.e., segmentation prediction, guided though the weakly-supervised module, and then these features can be aligned between the source and target domains.

In one or more embodiments, weak image-level annotations can be used for domain adaptation, either estimated, i.e., pseudo weak labels (Unsupervised Domain Adaptation, UDA) or acquired from a human expert (Weakly supervised Domain Adaptation (WDA). In one or more embodiments, an alignment method for aligning the category-wise features between the source and target domains can also be utilized. The model is able to simultaneously perform pseudo label re-training and feature alignment.

One practical usage is to leverage synthetic data, in which annotations can be obtained in a much lower cost. However, scene-understanding models learned from the synthetic data could not be generalized to real-world images. Therefore, our knowledge-transfer modules allow us to perform better scene understanding in the real world, which is a crucial component for facilitating autonomous systems or Advanced Driver Assistance Systems (ADAS) systems, including various tasks such as semantic segmentation, object detection, or depth estimation.

In various embodiments, the system is able to predict pseudo-weak labels in an unsupervised manner, as well as allowing users to provide ground truth weak labels for target images, which requires the minimum efforts for annotation, compared to annotating pixel-wise labels such as semantic segmentation. Semantic segmentation may also suffer from the complexity of high-dimensional features that needs to encode diverse visual cues, including, appearance, shape and context. A ground truth can specify whether an object is present in the image, rather than detailed information of where an object is located in an image.

In various embodiments, a classification objective that predicts whether one category presents in the target image can be formulated. The model can produce a pixel-wise attention map that indicates the probability map for a certain category. Then, this attention map can be utilized as the guidance to pool category-wise features for the further proposed alignment procedure. The approach is not limited to the conventional unsupervised setting (i.e., no ground truth annotations in the target domain), but also applicable to weakly-supervised domain adaptation (WDA), where image level ground truths are available in target images.

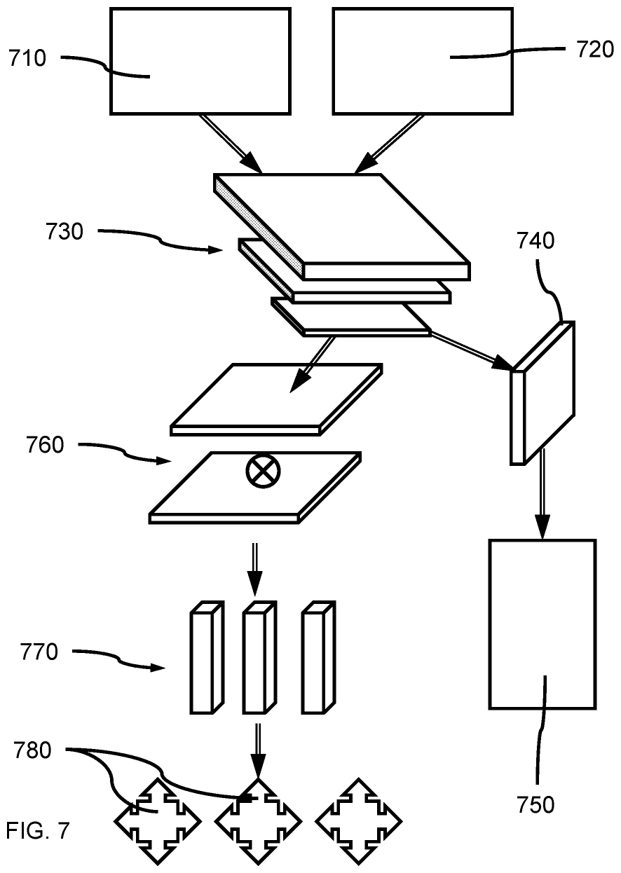

FIG. 7 is a block/flow diagram illustrating a system/method of passing both target and source images through a segmentation network G to obtain their features, and formulate a mechanism to align the features of each individual category between source and target domains, in accordance with an embodiment of the present invention.

FIG. 7 presents an overview of a proposed method. First both the target image(s) 710 and source image(s) 720 can be passed through a segmentation network, G, 730 to obtain their features Fₛ; Fₜ, ∈ [symbol] ^{H′×W′×2048}, where 2048 is a parameter choice for the number of channels, and segmentation predictions Aₛ; Aₜ∈ [symbol] ^{H′×W′×C}, and the up-sampled pixel-wise predictions Oₛ, Oₜ∈ [symbol] ^{H′×W′×C}, 740. As a baseline, the source pixel-wise annotations can be used to learn G, while aligning the output spaces, Oₛ and Oₜ, using an adversarial loss and a discriminator that utilizes all fully-convolutional layers to retain the spatial information. The segmentation network, G, can have 5 convolution layers with kernel 4×4 and stride of 2, where the channel number is {64, 128, 256, 512, 1}, respectively. Except for the last layer, each convolution layer is followed by a leaky ReLU parameterized by 0.2.

In various embodiments, the stride of the last two convolution layers is adjusted from 2 to 1, making the resolution of the output feature maps effectively 1=8 times the input image size. To enlarge the receptive field, we apply dilated convolution layers in conv4 and conv5 layers with a stride of 2 and 4, respectively. After the last layer, an Atrous Spatial Pyramid Pooling (ASPP) can be used as the final classifier. A discriminator with the same architecture is added for adversarial learning.

Based on this architecture, the segmentation model can achieve 65.1% mean intersection-over-union (IoU) when trained on the Cityscapes training set and tested on the Cityscapes validation set.

An up-sampling layer 740 can be added to the last convolution layer for re-scaling the output to the size of the input. Up sampling can provide source labels 750.

In various embodiments, the output prediction can be used as attention and category-wise pooling 760 to generate category-wise pooling features 770.

In various embodiments, the target images Xₜ can be fed through G to obtain the predictions Aₜ and then apply a global pooling layer to obtain a single vector of predictions for each category:

$${P}_{t}^{c} = {σ}_{s} [ log \frac{1}{{H}^{′} {W}^{′}} {\sum }_{{h}^{′} , {w}^{′}} {exp A}_{t}^{( {h}^{′} , {w}^{′} , c )} ] ,$$

where σₛ is the sigmoid function such that pₜ represents the probability that a particular category appears in an image. Aₜ is a feature map for segmentation predictions with C channels and spatial dimensions H′×W′. To feed it into a classifier, it must be converted to a vector of dimensions 1×1×C. That is achieved by an averaging operation. Using pₜ and the weak labels yₜ, the category-wise binary cross-entropy loss (or image classification loss) can be computed:

[symbol]

_{c}(Xₜ; G)=Σ_{c=1}^{C}−yₜ^{c} log(pₜ^{c})−(1−yₜ^{c})log(1−pₜ^{c}).

This loss function [symbol] _{c} helps to identify the categories which are absent/present in a particular image and enforces the segmentation network G to pay attention to those objects/stuff that are partially identified. This is a binary cross entropy loss, that takes the vector pₜ above and determines how well it matches the ground truth labels, yₜ.

Given the feature F in the last layer and the segmentation prediction A, we obtain the category-wise features by using the prediction as an attention over the features. Specifically, we obtain the category-wise feature F^{c} as a 2048-dimensional vector for the c^{th} category:

$${ℱ}^{c} = \frac{1}{{H}^{′} {W}^{′}} {\sum }_{{h}^{′} , {w}^{′}} {σ [ A ]}^{( {h}^{′} , {w}^{′} , c )} {ℱ}^{( {h}^{′} , {w}^{′} )} ,$$

where [A]^{(h′,w′,c)} is a scalar, [symbol] ^{(h′,w′)} is a 2048-dimensional vector for he category-wise feature, and σ is the softmax operation over the spatial dimensions (h′, w′). Note that the subscripts s, t were dropped for the source and target, as they employ the same operation to obtain the category-wise features for both domains. We next present the mechanism to align these features across domains. Note that we will use F^{c} (small c) to denote the pooled feature for the c^{th} category and F^{C} (capital C) to denote the set of pooled features for all the categories.

In various embodiments, the discriminator(s) 780 with the segmentation network can be jointly trained using a small batch size. To learn the segmentation network G such that the source and target category-wise features are aligned, an adversarial loss can be used, while using category-specific discriminators 780, D^{C}={D^{c}}_{c=1}^{C} The weak labels can be used to align these features between source and target domain using the category-wise discriminators D^{C} via the alignment loss [symbol] _{adv}^{C} and learn the discriminators using domain classification loss [symbol] _{d}^{C}.

In various embodiments, C category-specific discriminators can be trained to distinguish between category-wise features drawn from the source and target images. The loss function to train the discriminators are as follows:

[symbol]

_{d}^{C}( [symbol] ₛ^{C}, [symbol] ₜ^{C}, G, D^{C})=Σ_{c=1}^{C}−yₛ^{c} log D^{C}( [symbol] ₛ^{c})−yₜ^{c} log(1−D^{c}( [symbol] ₜ^{c}))

Note that, while training the discriminators, we only compute the loss for those categories which are present in the particular image via yₛ and yₜ. Then, the adversarial loss for the target images can be expressed as follows:

[symbol]

_{adv}^{C}( [symbol] ₜ^{C}, G, D^{C})=Σ_{c=1}^{C}−yₜ^{c} log D^{C}( [symbol] ₜ^{c})

The pooled features for the target domain images are represented by [symbol] ₜ^{C} and/or [symbol] ₜ^{c}. Similarly, the target weak labels, yₜ, can be used to align only those categories presenting in the target image. By minimizing [symbol] _{adv}^{C}, the segmentation network tries to fool the discriminator by maximizing the probability of the target category-wise feature being considered as the source distribution.

In various embodiments, the alignment of the output space Oₛ, Oₜ does not consider which categories are present in an image, but only their overall structure. As a result, for those objects that are usually identified partially or do not retain the complete shape, they may become less significant in the segmentation prediction, which increases the difficulty during alignment as such partial objects do not appear in the source data. In this paper, we introduce an auxiliary task via weak labels by enforcing constraints on the categories that appear in the images.

In various embodiments, a set of C distinct discriminators can be learned for each of the c category. The source and target images can be used to train the discriminators, which learn to distinguish between the category-wise features drawn from the source or target images. The objective is written as:

$${min}_{{D}^{C}} {ℒ}_{d}^{C} ( {ℱ}_{s}^{C} , {ℱ}_{t}^{C} ) .$$

Note that each discriminator can be trained with features pooled specific to that category.

In various embodiments, the segmentation network with the pixel-wise cross-entropy loss [symbol] ₛ on the source images, weak image classification loss [symbol] _{c} and adversarial loss [symbol] _{adv}^{C} on the target images. Combining the objective of segmentation network and discriminators, a min-max problem can be formulated:

$${min}_{G} {max}_{{D}^{c}} {ℒ}_{s} + {λ}_{c} {ℒ}_{c} ( {X}_{t} ) + {λ}_{d} {ℒ}_{a d v}^{C} ( {ℱ}_{t}^{C} )$$

We follow the standard Generative Adversarial Network (GAN) training procedure to alternatively update G and D^{C}. Note that, computing [symbol] _{adv}^{C} involves the category-wise discriminators D^{C}. Therefore, we fix D^{C} and backpropagate gradients only for the segmentation network G.

A mechanism can be used to utilize weak image-level labels of the target images to adapt the segmentation model between source and target domains. However, we can acquire the weak labels in multiple ways.

In various embodiments, weak labels can be acquired by directly estimating them on the available data, i.e., source images/labels and target images, which is the unsupervised domain adaptation (UDA) setting.

$${y}_{t}^{c} = \{ \begin{matrix}1 , if {p}_{t}^{c} > T \\ 0 , otherwise\end{matrix}$$

where pₜ^{c} is the probability for the c category as computed in (1) and T is a threshold, which can be set to 0.2 in the experiments unless specified otherwise. In practice, the weak labels can be computed online during training the framework, so that there is no additional training step involved. Specifically, we forward a target image, obtain the weak labels, and then compute the loss functions. As the weak labels obtained in this manner do not require human supervision, adaptation using such labels is unsupervised.

In this form, the weak labels can be obtained by querying a human oracle to provide a list of the categories occurring in the target image. As we use supervision from an oracle on the target images, this can be referred to as weakly-supervised domain adaptation (WDA). It is worth mentioning that the WDA setting could be practically useful, as collecting such human oracle of weak labels is much easier than pixel-wise annotations. Embodiments described herein may be entirely hardware, entirely software or including both hardware and software elements. In a preferred embodiment, the present invention is implemented in software, which includes but is not limited to firmware, resident software, microcode, etc.

For the segmentation network G, DeepLab-V2 can be used with the ResNet-101 architecture, following the UDA framework. Features Fₛ; Fₜ can be extracted before the Atrous Spatial Pyramid Pooling (ASPP) layer. For the category-wise discriminators

D^{C}={D^{c}}_{c=1}^{C},

C separate networks can be used, where each can include three fully-connected layers, with number of nodes {2048; 2048; 1} and the ReLU activation.

In various embodiments, the initial learning rates can be set to 2:5×10⁻⁴ and 1×10⁻⁴ for the segmentation network and discriminators, with a polynomial decay of power 0.9. λ^{c} can be chosen to be 0.2 for oracle weak labels and use a smaller λ^{c}=0.01 for pseudo weak labels to account for its inaccurate prediction, and can set λ_{adv}=0.001. Adaptation using weak labels aligns the features not only between the original source and target images, but also between the translated source images and the target images.

In various embodiments, these adapted images can be added to the source dataset, as their pixel-wise annotations do not change after adaptation. In this manner, adaptation using weak labels aligns the features not only between the original source and target images, but also between the translated source images and the target images.

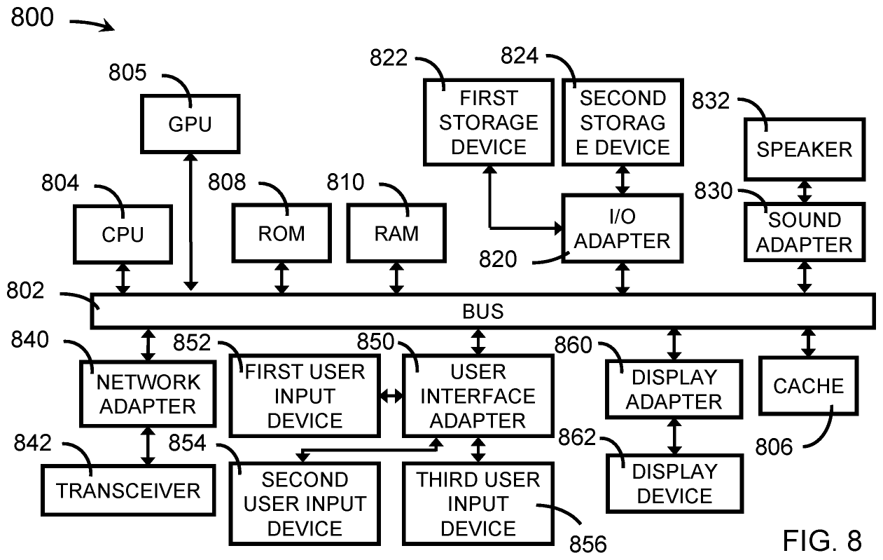

FIG. 8 is an exemplary processing system 800 to which the present methods and systems may be applied, in accordance with an embodiment of the present invention.

The processing system 800 can include at least one processor (CPU) 804 and may have a graphics processing (GPU) 805 that can perform vector calculations/manipulations operatively coupled to other components via a system bus 602. A cache 806, a Read Only Memory (ROM) 808, a Random Access Memory (RAM) 810, an input/output (I/O) adapter 820, a sound adapter 830, a network adapter 840, a user interface adapter 850, and a display adapter 860, can be operatively coupled to the system bus 802.

A first storage device 822 and a second storage device 824 are operatively coupled to system bus 802 by the I/O adapter 820. The storage devices 822 and 824 can be any of a disk storage device (e.g., a magnetic or optical disk storage device), a solidstate device, a magnetic storage device, and so forth. The storage devices 822 and 824 can be the same type of storage device or different types of storage devices.

A speaker 832 is operatively coupled to system bus 802 by the sound adapter 830. A transceiver 842 is operatively coupled to system bus 802 by network adapter 840. A display device 862 is operatively coupled to system bus 802 by display adapter 860.

A first user input device 852, a second user input device 854, and a third user input device 856 are operatively coupled to system bus 802 by user interface adapter 850. The user input devices 852, 854, and 856 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 852, 854, and 856 can be the same type of user input device or different types of user input devices. The user input devices 852, 854, and 856 can be used to input and output information to and from system 800.

In various embodiments, the processing system 800 may also include other elements (not shown), as readily contemplated by one of skill in the art, as well as omit certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 800 are readily contemplated by one of ordinary skill in the art given the teachings of the present principles provided herein.

Moreover, it is to be appreciated that system 800 is a system for implementing respective embodiments of the present methods/systems. Part or all of processing system 800 may be implemented in one or more of the elements of FIGS. 1-7. Further, it is to be appreciated that processing system 800 may perform at least part of the methods described herein including, for example, at least part of the method of FIGS. 1-7.

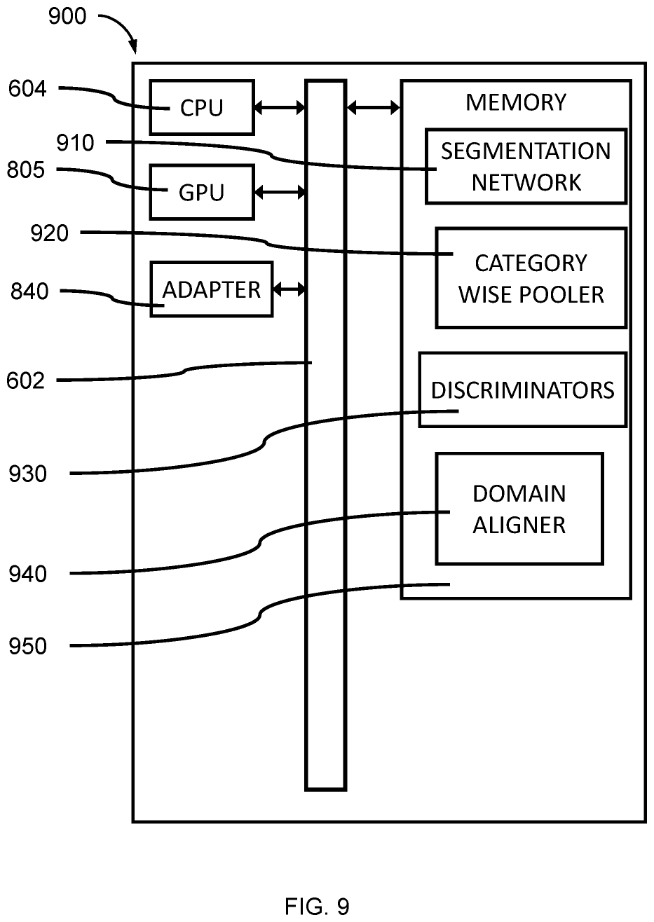

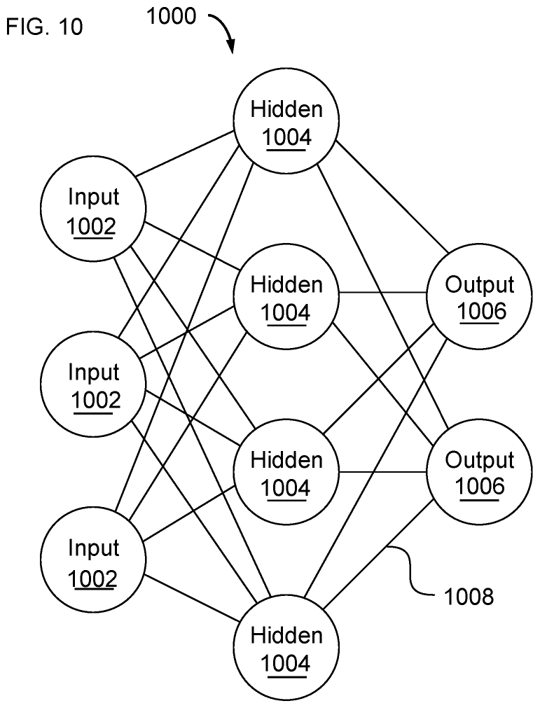

FIG. 9 is an exemplary processing system 900 configured to implement one or more neural networks for adapting semantic segmentation across domains, in accordance with an embodiment of the present invention.

In one or more embodiments, the processing system 900 can be a computer system 800 configured to perform a computer implemented method of adapting semantic segmentation across domains.

In one or more embodiments, the processing system 900 can be a computer system 800 having memory components 950, including, but not limited to, the computer system's random access memory (RAM) 810, hard drives 822, and/or cloud storage to store and implement a computer implemented method of using weak labels to improve semantic segmentation across domains. The memory components 950 can also utilize a database for organizing the memory storage.

In various embodiments, the memory components 950 can include a Segmentation Network 910 that can be configured to implement a neural network configured to model a source image and a target image. The Segmentation Network 910 can also be configured to receive as input digital images of different domains, and predict which categories present in that image. For example, given a road or city image in the target domain, which categories are present in that image can be predicted, e.g., road, car, truck, and pedestrian, without knowing their exact locations in the image. The Segmentation Network 910 can also be configured predict pseudo-weak labels in an unsupervised manner. Users can provide ground truth weak labels for target images.

In various embodiments, the memory components 950 can include a feature category wise pooler 920 configured to provide segmentation prediction pool features. An attention map can be used for guidance to pool category-wise features for the further proposed alignment procedure. The feature category wise pooler 920 configured to have a global pooling layer to obtain a single vector of predictions for each category.

In various embodiments, the memory components 950 can include Discriminator(s) 930 configured to distinguish between category-wise features drawn from the source and target images. The Discriminator(s) 930 can be trained on source and target images, and used with the weak labels to align features between source and target images. An adversarial loss function can be used to train Category-wise discriminators to distinguish between category-wise features drawn from the source and target images. Each of one or more discriminator(s) can be trained with features pooled specific to a category.

In various embodiments, the memory components 950 can include a Domain Aligner 940 configured to use the weak labels to align these features between source and target domains using the category-wise discriminators using the alignment loss and train the discriminators using domain classification loss. The Domain Aligner 940 can also be configured to perform category-wise feature alignment across domains, in which only categories that present in the image are used for alignment.

FIG. 10 is a block diagram illustratively depicting an exemplary neural network 1000 in accordance with another embodiment of the present invention.

A neural network 1000 may include a plurality of neurons/nodes 1001, and the nodes 1008 may communicate using one or more of a plurality of connections 1008. The neural network 1000 may include a plurality of layers, including, for example, one or more input layers 1002, one or more hidden layers 1004, and one or more output layers 1006. In one embodiment, nodes 1001 at each layer may be employed to apply any function (e.g., input program, input data, etc.) to any previous layer to produce output, and the hidden layer 1004 may be employed to transform inputs from the input layer (or any other layer) into output for nodes 1001 at different levels.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for adapting semantic segmentation across domains, comprising:
inputting a source image into a segmentation network;
inputting a target image into the segmentation network;
identifying category wise features for the source image and the target image using category wise pooling;
discriminating between the category wise features for the source image and the target image;
training the segmentation network with a pixel-wise cross-entropy loss on the source image, and a weak image classification loss and an adversarial loss on the target image; and
outputting a semantically segmented target image.

2. The method of claim 1, wherein a GAN training procedure is used to update the segmentation network.

3. The method of claim 1, wherein the adversarial loss calculated for target images is given by [symbol] _{adv}^{C}( [symbol] ₜ^{C}, G, D^{C})=Σ_{c=1}^{C}−yₜ^{c} log D^{C}( [symbol] ₜ^{c}), where [symbol] _{adv}^{C} is a category-specific adversarial loss, [symbol] ₜ^{C} represents the pooled features for the target domain images, G is the segmentation network, D^{C} is a category-specific domain discriminator, c is an index for categories, C, and yₜ^{c} represents category-wise target weak labels.

4. The method of claim 1, further comprising using target weak labels yₜ to align categories in the target image.

5. The method of claim 4, further comprising using category-specific domain discriminators guided by the target weak labels to determine which categories should be aligned.

6. The method of claim 5, further comprising obtaining weak labels by querying a human oracle to provide a list of categories occurring in the target image.

7. The method of claim 6, further comprising obtaining weak labels by unsupervised domain adaptation.

8. A processing system for adapting semantic segmentation across domains, comprising:
one or more processor devices;
a memory in communication with at least one of the one or more processor devices; and
a display screen;
wherein the processing system includes:
a segmentation network configured to receive a source image and receive a target image;
a category wise pooler configured to identify category wise features for the source image and the target image using category wise pooling;
a discriminator configured to discriminate between the category wise features for the source image and the target image;
wherein the segmentation network is trained based on a pixel-wise cross-entropy loss on the source image, and a weak image classification loss and an adversarial loss on the target image, and outputs a semantically segmented target image on the display screen.

9. The processing system of claim 8, wherein a GAN training procedure is used to update the segmentation network.

10. The processing system of claim 8, wherein the adversarial loss calculated for target images is given by [symbol] _{adv}^{C}( [symbol] ₜ^{C}, G, D^{D})=Σ_{c=1}^{C}−yₜ^{c} log D^{C}( [symbol] ₜ^{c}), where [symbol] _{adv}^{C} is a category-specific adversarial loss, [symbol] ₜ^{C} represents the pooled features for the target domain images, G is the segmentation network, D^{C} is a category-specific domain discriminator, c is an index for categories, C, and yₜ^{c} represents category-wise target weak labels.

11. The processing system of claim 8, further comprising a domain aligner configured to use target weak labels, yₜ, to align categories in the target image.

12. The processing system of claim 11, further comprising use category-specific domain discriminators guided by the target weak labels to determine which categories should be aligned.

13. The processing system of claim 12, further comprising obtaining weak labels by querying a human oracle to provide a list of categories occurring in the target image.

14. A non-transitory computer readable storage medium comprising a computer readable program for producing a road layout model, wherein the computer readable program when executed on a computer causes the computer to perform the steps of:
inputting a source image into a segmentation network;
inputting a target image into the segmentation network;
identifying category wise features for the source image and the target image using category wise pooling;
discriminating between the category wise features for the source image and the target image;
training the segmentation network with a pixel-wise cross-entropy loss on the source image, and a weak image classification loss and an adversarial loss on the target image; and
outputting a semantically segmented target image.

15. The computer readable program of claim 14, wherein a GAN training procedure is used to update the segmentation network.

16. The computer readable program of claim 14, wherein the adversarial loss calculated for target images is given by [symbol] _{adv}^{C}( [symbol] ₜ^{C}, G, D^{C})=Σ_{c=1}^{C}−yₜ^{c} log D^{C}( [symbol] ₜ^{c}), where [symbol] _{adv}^{C} is a category-specific adversarial loss [symbol] ₜ^{C}, represents the pooled features for the target domain images, G is the segmentation network, D^{C} is a category-specific domain discriminator, c is an index for categories, C, and yₜ^{c} represents category-wise target weak labels.

17. The computer readable program of claim 14, further comprising using target weak labels yₜ to align categories in the target image.

18. The computer readable program of claim 17, further comprising use category-specific domain discriminators guided by the target weak labels to determine which categories should be aligned.

19. The computer readable program of claim 18, further comprising obtaining weak labels by querying a human oracle to provide a list of categories occurring in the target image.

20. The computer readable program of claim 19, further comprising obtaining weak labels by unsupervised domain adaptation.
